(19) United States
(12) Patent Application Publication
(10) Pub. No.: US 2025/0289930 A1
(43) Pub. Date: Sep. 18, 2025

(54) POLYIMIDE FILM HAVING LOW DIELECTRIC AND HIGH HEAT RESISTANT PROPERTIES AND PREPARATION METHOD THEREFOR

(71) Applicant: PI ADVANCED MATERIALS CO., LTD, Chungcheongbuk-do (KR)

(72) Inventors: Young-Jin JUNG, Seoul (KR); Dong-Young WON, Chungcheongbuk-do (KR); Sung-Yul BACK, Seoul (KR); Min-Sang CHO, Incheon (KR); Su-Kyung CHAE, Incheon (KR)

(21) Appl. No.: 18/860,296

(22) PCT Filed: Apr. 27, 2023
(86) PCT No.: PCT/KR2023/005813

§ 371 Date: Oct. 25, 2024

(30) Foreign Application Priority Data
Apr. 29, 2022 (KR) 10-2022-0053662

(51) Int. Cl. C08G 73/10; B32B 15/08; B32B 15/20; C08G 81/00

(52) U.S. Cl. CPC C08G 73/1082; B32B 15/08; B32B 15/20; C08G 73/1032; C08G 81/00; B32B 2307/202

(57) ABSTRACT

Provided is a polyimide film that is prepared by imidizing a polyamic acid solution containing two or more dianhydride components selected from the group consisting of biphenyltetracarboxylic dianhydride (BPDA), pyromellitic dianhydride (PMDA), and p-phenylenebis(trimellitate anhydride) (TAHQ), and at least one diamine component selected from oxydianiline (ODA), p-phenylenediamine (PPD), and m-tolidine (mTD), and that has a dielectric dissipation factor (Df) of 0.0025 or less and a glass transition temperature (Tg) of 240° C. or more.

### TECHNICAL FIELD

The present disclosure relates to a polyimide film having excellent low dielectric and heat resistance properties.

### BACKGROUND ART

Polyimide (PI) has a rigid aromatic backbone and is based on an imide ring with excellent chemical stability. Thus, polyimide (PI) is a polymer material with the highest level of heat resistance, chemical resistance, electrical insulation, chemical resistance, and weather resistance among organic materials.

In particular, thanks to excellent insulating properties, which means excellent electrical properties such as low permittivity, polyimide has attracted attention as a high-functional polymer material in various fields including electrical, electronic, and optical fields.

Recently, as electronic products become lighter and smaller, thin circuit boards with high integration and flexibility are being actively developed.

These thin circuit boards widely used these days have a structure in which a circuit including a metal foil is formed on a polyimide film, which has excellent heat resistance, low temperature resistance, and insulation properties while also being easy to bend.

Flexible metal foil clad laminates are mainly used as the thin circuit boards. For example, the flexible metal foil clad laminates include flexible copper clad laminates (FCCLs) that use a thin copper plate as a metal foil. In addition, polyimide is also used as a protective film or an insulating film for thin circuit boards.

Meanwhile, with recent various functions embedded in electronic devices, fast computational speed and communication speed are required in the use of the electronic devices. To meet this need, thin circuit boards capable of high-speed, high-frequency communication are being developed.

To achieve the high-frequency, high-speed communication, an insulator with high impedance capable of maintaining electrical insulation even at high frequencies is required. Impedance is inversely proportional to a frequency and dielectric constant (Dk) characteristic of an insulator. To maintain insulation even at high frequencies, a dielectric constant is required to be as low as possible.

However, the reality is that the dielectric properties of conventional polyimides are not good enough to maintain sufficient insulation in high-frequency communication.

Additionally, when an insulator has lower dielectric properties, the insulator may reduce the occurrence of undesirable stray capacitance and noise in thin circuit boards, thereby it is known that an insulator with lower dielectric properties may significantly resolve the cause of communication delay.

Accordingly, polyimide with low dielectric properties is recognized as the most important factor in the performance of thin circuit boards.

In particular, with the use of polyimide in the case of high-frequency communication, dielectric dissipation inevitably occurs. A dielectric dissipation factor (Df) refers to the degree of electrical energy wasted in thin circuit boards and is closely related to a signal transmission delay, which determines the communication speed. Thus, keeping a dielectric dissipation factor of polyimide as low as possible is also recognized as an important factor in the performance of thin circuit boards.

Additionally, the more moisture is contained in the polyimide film, the higher the dielectric constant and the higher the dielectric dissipation factor. A polyimide film is suitable as a material for thin circuit boards due to excellent unique properties, but the polyimide film may be relatively vulnerable to moisture due to the polar imide groups thereof, which may result in a deterioration in the insulating properties of the polyimide film.

Therefore, there is a need to develop a polyimide film having dielectric properties, especially a low dielectric dissipation factor while maintaining mechanical properties, thermal properties, and high-adhesion surface properties unique to polyimide at a predetermined level.

### RELATED ART DOCUMENT

### Patent Document

(Patent Document 1) Korean Patent Application Publication No. 10-2021-0055230

### DISCLOSURE

### Technical Problem

To address the issues, the present disclosure is to provide a polyimide film having excellent low dielectric and heat-resistant properties.

### Technical Solution

To achieve the objective, one embodiment of the present disclosure provides a polyimide film prepared by imidizing a polyamic acid solution containing a dianhydride component including two or more types selected from the group consisting of biphenyltetracarboxylic dianhydride (BPDA), pyromellitic dianhydride (PMDA), and p-phenylenebis(trimellitate anhydride) (TAHQ); and
a diamine component including two or more types selected from the group consisting of oxydianiline (ODA), p-phenylenediamine (PPD), and m-tolidine (mTD).

Herein, the dianhydride component of the polyimide film is required to include biphenyltetracarboxylic dianhydride and p-phenylenebis(trimellitate anhydride).

Another embodiment of the present disclosure provides a polyimide film, in the preparation of which, the biphenyltetracarboxylic dianhydride (BPDA), the pyromellitic dianhydride (PMDA), and the p-phenylenebis(trimellitate dianhydride anhydride) (TAHQ) are contained in amounts of 30 mol % to 70 mol %, 40 mol % or less, and 15 mol % to 35 mol %, respectively, based on 100 mol % of the dianhydride component.

A further embodiment of the present disclosure provides a polyimide film, in the preparation of which, the oxydianiline (ODA), the p-phenylenediamine (PPD), and the m-tolidine are contained in amounts of 35 mol % or less, 55 mol % or less, and 45 mol % or more, respectively, based on 100 mol % of the diamine component.

A yet further embodiment of the present disclosure provides a polyimide film including a block copolymer made of two or more blocks.

A still yet further embodiment of the present disclosure provides a polyimide film including a block copolymer, in which the block copolymer includes a first block obtained by bringing a dianhydride component and a diamine component into an imidization reaction, the dianhydride component including the p-phenylenebis(trimellitate anhydride) (TAHQ) and the diamine component including the m-tolidine (mTD) and oxydianiline (ODA); and a second block obtained by bringing a dianhydride component and a diamine component into the imidization reaction, the dianhydride component including the biphenyltetracarboxylic dianhydride (BPDA) and pyromellitic dianhydride (PMDA) and the diamine component including the m-tolidine (mTD) and p-phenylenediamine (PPD).

A still yet further embodiment of the present disclosure provides a polyimide film having a dielectric dissipation factor (Df) of 0.0025 or less and a glass transition temperature (Tg) of 240° C. or higher.

A still yet further embodiment of the present disclosure provides a method of preparing a polyimide film, the method including: preparing a polyamic acid solution by polymerizing a dianhydride component and a diamine component, the dianhydride component including two or more types selected from the group consisting of biphenyltetracarboxylic dianhydride (BPDA), pyromellitic dianhydride (PMDA), and p-phenylenebis(trimellitate anhydride) (TAHQ), and the diamine component including two or more types selected from the group consisting of oxydianiline (ODA), p-phenylenediamine (PPD), and m-tolidine (mTD); and imidizing the polyamic acid solution.

Herein, the dianhydride component in the method of preparing a polyimide film is required to include biphenyltetracarboxylic dianhydride and p-phenylenebis(trimellitate anhydride).

A still yet further embodiment of the present disclosure provides a method of preparing a polyimide film, in the preparation of which, the biphenyltetracarboxylic dianhydride (BPDA), the pyromellitic dianhydride (PMDA), and the p-phenylenebis(trimellitate anhydride) (TAHQ) are contained in amounts of 30 mol % to 70 mol %, 40 mol % or less, and 15 mol % to 35 mol %, respectively, based on 100 mol % of the dianhydride component.

A still yet further embodiment of the present disclosure provides a method of preparing a polyimide film.

In the preparation of the polyimide film, the oxydianiline (ODA), the p-phenylenediamine (PPD), and the m-tolidine are contained in amounts of 35 mol % or less, 55 mol % or less, and 45 mol % or more, respectively, based on 100 mol % of the diamine component.

A still yet further embodiment of the present disclosure provides a method of preparing a polyimide film having a dielectric dissipation factor (Df) of 0.0025 or less and a glass transition temperature (Tg) of 240° C. or higher.

A still yet further embodiment of the present disclosure provides a multilayer film including the polyimide film.

A still yet further embodiment of the present disclosure provides a multilayer film including the polyimide film and a thermoplastic resin layer.

A still yet further embodiment of the present disclosure provides a flexible metal foil clad laminate including the polyimide film and an electrically conductive metal foil.

A still yet further embodiment of the present disclosure provides an electronic component including the flexible metal foil clad laminate.

### Advantageous Effects

As explained above, the present disclosure prepares a polyamic acid solution containing specific components in a specific composition ratio by imidization and provides a polyimide film having low dielectric and high heat resistant properties, thereby the present disclosure can apply in various fields in need of the properties, in particular, to an electronic component such as a flexible metal foil clad laminate.

### BEST MODE

Herein below, embodiments of the present disclosure are described in more detail.

Prior to this, terms or words used in this specification and claims should not be interpreted as limited to their usual or dictionary meanings. Based on the principle that inventor(s) may appropriately define the concept of terms to best explain his or her present disclosure, the terms and words should be interpreted in a meaning and concept that conforms to the technical idea of the present disclosure.

Therefore, the configuration of the embodiments described in this specification is only one of the most preferred embodiments of the present disclosure. The configuration does not represent all the technical ideas of present disclosure. Thus, it should be understood that at the time of this application, there may be various equivalents and modifications that may be substituted for these.

In this specification, singular expressions include plural expressions unless the context clearly indicates otherwise. In this specification, the terms “include”, “comprise”, or “have” are intended to specify the presence of a feature, number, step, component, or combination thereof. It should be understood that these words do not exclude the presence or addition of one or more other features, numbers, steps, components, or combinations thereof.

When quantities, concentrations, or other values or parameters are given in this specification as ranges, preferred ranges, or enumerations of preferred upper and lower values, it should be understood that any range formed by any pair of any upper range limit or preferred value and any lower range limit or preferred value is specifically disclosed, whether or not the ranges are separately disclosed.

When a range of numeric values is mentioned in this specification, unless otherwise stated, the range is intended to include the endpoints thereof and all integers and fractions within the range. It is intended that the scope of the present disclosure is not limited to the specific values mentioned when defining the scope.

As used herein, the term “dianhydride” is intended to include precursors or derivatives thereof, and the precursors or derivatives may not technically be dianhydride. However, the precursors or derivatives will react with diamine to form polyamic acid, which may then be converted into polyimide.

As used herein, the term “diamine” is intended to include a precursor or a derivative thereof, and the precursor or the derivative thereof may not technically be diamine. However, the precursor or the derivative thereof will react with dianhydride to form polyamic acid, which may then be converted into polyimide.

A polyimide film according to the present disclosure may be prepared by imidizing a polyamic acid solution containing a dianhydride component including two or more types selected from the group consisting of biphenyltetracarboxylic dianhydride (BPDA), pyromellitic dianhydride (PMDA), and p-phenylenebis(trimellitate anhydride) (TAHQ), and a diamine component including two or more types selected from the group consisting of oxydianiline (ODA), p-phenylenediamine (PPD), and m-tolidine (mTD).

Herein, the dianhydride component may include biphenyltetracarboxylic dianhydride and p-phenylenebis(trimellitate anhydride).

For example, the polyimide film may include (1) a polyimide film prepared by imidizing polyamic acid which includes a dianhydride component including p-phenylenebis(trimellitate anhydride) (TAHQ) and biphenyltetracarboxylic dianhydride (BPDA) and a diamine component including m-tolidine (mTD), oxydianiline (ODA), and p-phenylenediamine (PPD); (2) a polyimide film prepared by imidizing polyamic acid which includes a dianhydride component including p-phenylenebis(trimellitate anhydride) (TAHQ), biphenyltetracarboxylic dianhydride (BPDA), and pyromellitic dianhydride (PMDA) and a diamine component including m-tolidine (mTD) and p-phenylenediamine (PPD); (3) a polyimide film prepared by imidizing polyamic acid which includes a dianhydride component including p-phenylenebis(trimellitate anhydride) (TAHQ), biphenyltetracarboxylic dianhydride (BPDA), and pyromellitic dianhydride (PMDA) and a diamine component including m-tolidine (mTD) and oxydianiline (ODA); or (4) a polyimide film prepared by imidizing polyamic acid which includes a dianhydride component including p-phenylenebis(trimellitate anhydride) (TAHQ), biphenyltetracarboxylic dianhydride (BPDA), and pyromellitic dianhydride (PMDA) and a diamine component including m-tolidine (mTD), oxydianiline (ODA), and p-phenylenediamine (PPD).

In one embodiment of the present disclosure, the biphenyltetracarboxylic dianhydride (BPDA), the pyromellitic dianhydride (PMDA), the p-phenylenebis(trimellitate and anhydride) (TAHQ) may be contained in amounts of 30 mol % to 70 mol %, 40 mol % or less, and 15 mol % to 35 mol %, respectively, based on 100 mol % of the dianhydride component. Preferably, the biphenyltetracarboxylic dianhydride (BPDA), the pyromellitic dianhydride (PMDA), and the p-phenylenebis(trimellitate anhydride) (TAHQ) may be contained in amounts of 35 mol % to 65 mol %, 35 mol % or less, and 20 mol % to 35 mol %, respectively, based on 100 mol % of the dianhydride component.

A polyimide chain derived from the biphenyltetracarboxylic dianhydride (BPDA) has a structure of charge transfer complex (CTC). That is a regular linear structure in which an electron donor and electron acceptor are positioned close to each other. Thereby intermolecular interactions are strengthened.

This structure has the effect of preventing hydrogen bonding with moisture. Therefore, this structure may maximize the effect of lowering the hygroscopicity of a polyimide film by having an influence on the lowering of a moisture absorption rate.

For a polyimide film to simultaneously have appropriate elasticity and moisture absorption rate, the content ratio of dianhydride is particularly important. For example, as the content ratio of biphenyltetracarboxylic dianhydride (BPDA) decreases, it becomes difficult to expect a low moisture absorption rate due to the CTC structure.

In addition, the biphenyltetracarboxylic dianhydride (BPDA) contains two benzene rings corresponding to the aromatic portion, whereas pyromellitic dianhydride (PMDA) contains one benzene ring corresponding to the aromatic portion.

Since the pyromellitic dianhydride (PMDA) is a dianhydride component with a relatively rigid structure, the pyromellitic dianhydride (PMDA) is preferable in that the pyromellitic dianhydride (PMDA) may provide appropriate elasticity to the polyimide film.

The increase in the pyromellitic dianhydride (PMDA) content may be understood as an increase in the imide group within the molecule based on the same molecular weight. This may be understood as a relative increase in the ratio of imide groups derived from the pyromellitic dianhydride (PMDA) in a polyimide polymer chain compared to that of the imide groups derived from the biphenyltetracarboxylic dianhydride (BPDA).

That is, the increase in the pyromellitic dianhydride content may be seen as a relative increase in the imide group for the entire polyimide film. Due to this, it makes it difficult to expect a low moisture absorption rate.

In the case of the biphenyltetracarboxylic dianhydride (BPDA) content ranging above 70 mol %, the heat resistance of the polyimide film may be reduced when a flexible metal foil clad laminate is prepared.

Conversely, in the case of the biphenyltetracarboxylic dianhydride (BPDA) content ranging below 30 mol % or the pyromellitic dianhydride (PMDA) content ranging above 40 mol %, achieving appropriate levels of dielectric constant, low dielectric dissipation properties, and glass transition temperature may be difficult.

In addition, in the case of the p-phenylenebis(trimellitate anhydride) (TAHQ) content above 35 mol %, achieving an appropriate glass transition temperature may be difficult. In the case of the p-phenylenebis(trimellitate anhydride) (TAHQ) content below 15 mol %, achieving low dielectric dissipation properties may be difficult.

In another embodiment of the present disclosure, the oxydianiline (ODA), the p-phenylenediamine (PPD), and the m-tolidine may be contained in amounts of 35 mol % or less, 55 mol % or less, and 45 mol % or more, respectively, based on 100 mol % of the diamine component. Preferably, the oxydianiline (ODA), the p-phenylenediamine (PPD), and the m-tolidine may be contained in amounts of 30 mol % or less, 50 mol % or less, and 50 mol % or more, respectively, based on 100 mol % of the diamine component.

The oxydianiline (ODA) or the p-phenylenediamine (PPD) may not be included at all.

In addition, the m-tolidine is necessarily included as the diamine component. The m-tolidine may be contained, for example, in an amount of 90 mol % or less, or 85 mol % or less.

The m-tolidine has a methyl group that is particularly hydrophobic, which contributes to the low moisture absorption properties of the polyimide film.

In the case of the oxydianiline (ODA) content above 35 mol %, not only does the glass transition temperature decrease, but the low dielectric dissipation properties may also deteriorate. In the case of the p-phenylenediamine (PPD) content above 55 mol %, there is a concern that the low dielectric dissipation properties may deteriorate. In the case of the m-tolidine content below 45 mol %, low dielectric dissipation properties may deteriorate.

Meanwhile, the polyimide film of the present disclosure may include a block copolymer made of two or more blocks, and in particular may include two blocks.

The polyimide film of the present disclosure may include a first block obtained by bringing a dianhydride component and a diamine component into an imidization reaction, the dianhydride component including the p-phenylenebis(trimellitate anhydride) (TAHQ) and the diamine component including the m-tolidine (mTD) and oxydianiline (ODA); and a second block obtained by bringing a dianhydride component and a diamine component into an imidization reaction, the dianhydride component including the biphenyltetracarboxylic dianhydride (BPDA) and pyromellitic dianhydride (PMDA) and the diamine component including the m-tolidine (mTD) and p-phenylenediamine (PPD).

By adjusting the blocks of the block copolymer, the polyimide film may have excellent dielectric dissipation factor (Df) properties through the first block, and at the same time, secure high temperature stability by increasing the glass transition temperature through the second block.

In a further embodiment of the present disclosure, the polyimide film may have a dielectric constant (Dk) of 3.5 or less, a dielectric dissipation factor (Df) of 0.0025 or less, and a glass transition temperature (Tg) of 240° C. or more.

In this regard, in the case of a polyimide film that satisfies all of the conditions in the dielectric constant (Dk), dielectric dissipation factor (Df), and glass transition temperature, the polyimide film may be used as an insulating film for a flexible metal foil clad laminate, as well as, even when the flexible metal foil clad laminate prepared is used as an electrical signal transmission circuit that transmits signals at a high frequency of 10 GHz or higher, the insulation stability of the flexible metal foil clad laminate may be secured, and signal transmission delay may also be minimized.

Meanwhile, the preparation of a polyamic acid, for example, may be carried out by:
(1) a polymerizing method with placing the entire amount of a diamine component in a solvent and then adding a dianhydride component in a substantially equimolar amount to the diamine component,
(2) a polymerizing method with placing the entire amount of a dianhydride component in a solvent and then adding a diamine component in a substantially equimolar amount to the dianhydride component,
(3) a polymerizing method with making a diamine component and a dianhydride component substantially equimolar by first adding some of the diamine component into a solvent, then mixing some of the dianhydride component at a ratio of about 95 mol % to 105 mol % relative to the reactive component, followed by sequentially adding the remaining diamine component and then the remaining dianhydride component,
(4) a polymerizing method with making a diamine component and a dianhydride component substantially equimolar by first adding the dianhydride component into a solvent, then mixing some of the diamine component at a ratio of about 95 mol % to 105 mol % relative to the reactive component, followed by sequentially adding the remaining dianhydride component and then the remaining diamine component,
(5) a polymerizing method with making an entire diamine component and dianhydride component substantially equimolar in the reaction by mixing first and second compositions. In a method of mixing first and second compositions and completing polymerization, the first composition is formed by reacting some of the diamine component and some of the dianhydride component in a solvent so that any one of the two components is in excess, and the second composition is formed in another solvent by reacting some of the diamine component and some of the dianhydride component so that any one of the two components is in excess. In the formation of the first composition, when the diamine component is excessive, the dianhydride component is excessive in the second composition, and when the diamine component is excessive in the first composition, the diamine component is excessive in the second composition.

However, the polymerization methods are not limited to the examples. It goes without saying that any known method may be used to prepare the first and second polyamic acids.

In a yet further embodiment of the present disclosure, a method of preparing a polyimide film includes: preparing polyamic acid solution by polymerizing a dianhydride component and a diamine component, the dianhydride component including two or more types selected from the group consisting of biphenyltetracarboxylic dianhydride (BPDA), pyromellitic dianhydride (PMDA), and p-phenylenebis(trimellitate anhydride) (TAHQ), and the diamine component including two or more types selected from the group consisting of oxydianiline (ODA), p-phenylenediamine (PPD), and m-tolidine (mTD); and imidizing the polyamic acid solution.

Herein, the dianhydride component of the polyimide film may include biphenyltetracarboxylic dianhydride and p-phenylenebis(trimellitate anhydride).

A polyimide film may be prepared by reacting the dianhydride component and diamine component in a set order for co-polymerization.

In a still yet further embodiment of the present disclosure, the biphenyltetracarboxylic dianhydride (BPDA), the pyromellitic dianhydride (PMDA), and the p-phenylenebis(trimellitate anhydride) (TAHQ) may be contained in amounts of 30 mol % to 70 mol %, 40 mol % or less, and 15 mol % to 35 mol %, respectively, based on 100 mol % of the dianhydride component. Preferably, the biphenyltetracarboxylic dianhydride (BPDA), the pyromellitic dianhydride (PMDA), and the p-phenylenebis(trimellitate anhydride) (TAHQ) may be contained in amounts of 35 mol % or more and 65 mol % or less, 35 mol % or less, and 20 mol % or more and 35 mol % or less, respectively, based on 100 mol % of the dianhydride component.

In a still yet further embodiment of the present disclosure, the oxydianiline (ODA), p-phenylenediamine (PPD), and m-tolidine may be contained in amounts of 35 mol % or less, 55 mol % or less, and 45 mol % or more, respectively, based on 100 mol % of the diamine component.

Preferably, the oxydianiline (ODA), the p-phenylenediamine (PPD), and the m-tolidine may be contained in amounts of 30 mol % or less, 50 mol % or less, and 50 mol % or more, respectively, based on 100 mol % of the diamine component. The oxydianiline (ODA) or the p-phenylenediamine (PPD) may not be included at all.

In addition, the m-tolidine is necessarily included as the diamine component. The m-tolidine may be contained, for example, in an amount of 90 mol % or less, or 85 mol % or less.

In the present disclosure, the polymerizing method of the polyamic acid as described above may be a random polymerizing method. A polyimide film prepared with the polyamic acid of the present disclosure prepared through the process may be preferably applied in terms of maximizing the effect of the present disclosure, which is to lower the dielectric dissipation factor (Df) and moisture absorption rate.

However, in the polymerizing method, the length of the repeating unit within the polymer chain described above is prepared to be relatively short. Due to that, there may be limitations in demonstrating each of the excellent properties of the polyimide chain derived from the dianhydride component. Therefore, the polymerizing method of polyamic acid that may be particularly preferably used in the present disclosure may be a block polymerizing method.

Meanwhile, a solvent for synthesizing the polyamic acid is not particularly limited. Any solvent that dissolves polyamic acid may be used, but an amide solvent is preferred.

The polyimide film prepared according to the method of preparing a polyimide film may have a dielectric constant (Dk) of 3.5 or less, a dielectric dissipation factor (Df) of 0.0025 or less, and a glass transition temperature (Tg) of 240° C. or more.

In a still yet further embodiment of the present disclosure, provided are a multilayer film including the polyimide film, a multilayer film including the polyimide film and a thermoplastic resin layer, and a flexible metal foil clad laminate including the polyimide film and an electrically conductive metal foil.

The thermoplastic resin layer may be, for example, a thermoplastic polyimide resin layer.

There is no particular limitation on a metal foil used. However, when the flexible metal foil clad laminate of the present disclosure is used for electronic devices or electrical devices, the metal foil used may include, for example, a metal foil including copper or an alloy thereof, stainless steel or an alloy thereof, nickel or an alloy thereof (including alloy 42), or aluminum or an alloy thereof.

Copper foils called a rolled copper foil and an electrolytic copper foil are widely used in general flexible metal foil clad laminates, and the copper foils may also be preferably used in the present disclosure. Additionally, the surface of these metal foils may be coated to have a rust-proofing layer, a heat-resistant layer, or an adhesive layer.

In the present disclosure, there is no particular limitation on the thickness of the metal foil. However, the metal foil is required to have any thickness to sufficiently function for its intended use.

The flexible metal foil clad laminate according to the present disclosure may have a structure in which a metal foil is laminated on one side of the polyimide film. Alternatively, the flexible metal foil clad laminate may have a structure in which an adhesive layer containing thermoplastic polyimide on one side of the polyimide film is added, and the metal foil is laminated while attached to the adhesive layer.

Meanwhile, in a still yet further embodiment of the present disclosure, provided may be an electronic component including the flexible metal foil clad laminate as an electrical signal transmission circuit. The electrical signal transmission circuit included into the electronic component may transmit a signal at a high frequency of at least 2 GHz, specifically at a high frequency of at least 5 GHz, and more specifically at a high frequency of at least 10 GHz.

By controlling the high hygroscopicity of the polyimide film, which affects the electrical signal transmission loss, it may achieve transmission loss optimization at frequencies of 10 GHz or more and a dielectric dissipation factor (Df) of 0.0025 or less.

The electronic component may include, but is not limited to, a communication circuit for a mobile terminal, a communication circuit for a computer, or a communication circuit for aerospace.

### Mode for Disclosure

Hereinafter, the operation and effect of the present disclosure will be described in more detail through specific examples of the present disclosure. However, these examples are provided only as examples of the present disclosure and do not define the scope of the present disclosure.

### Preparation Example (Preparation of Polyimide Film)

DMF was added while nitrogen was injected into a 500 ml reactor equipped with a stirrer and a nitrogen injection/discharge pipe. The temperature of the reactor was set to a temperature of 30° C. Thereafter, a diamine monomer and a dianhydride monomer were added in a set order, and then a complete dissolution of the diamine monomer and the dianhydride monomer was confirmed.

Next, the temperature of the reactor was raised to a temperature of 40° C. under a nitrogen atmosphere, and stirring was continued for 120 minutes. Through this, a block copolymerized polyamic acid was prepared.

By adding a catalyst and a dehydrating agent to the polyamic acid prepared in this manner in controlled amounts, a polyimide precursor composition was prepared. Thereafter, a de-foamed polyimide precursor composition was applied to a glass substrate using a spin coater. Afterward, a gel film was prepared by drying at a temperature of 120° C. for 30 minutes under a nitrogen atmosphere. The gel film was heated to a temperature of 450° C. at a rate of 2° C./min, heat-treated at a temperature of 450° C. for 60 minutes, and cooled to a temperature of 30° C. at a rate of 2° C./min. Through this, a polyimide film was obtained.

### Examples 1 to 5 and Comparative Examples 1 to 4

Polyimide films were prepared following the procedure described in the Preparation Example with the content of a dianhydride component and a diamine component adjusted in Examples 1 to 5 and Comparative Examples 1 to 4 as shown in Table 1 below.

TABLE 1

| | Diamine | | | Dianhydride | | |
|---|---|---|---|---|---|---|
| | mTB | ODA | PPD | TAHQ | BPDA | PMDA |
| Example 1 | 50 | 30 | 20 | 35 | 65 | 0 |
| Example 2 | 50 | 0 | 50 | 25 | 55 | 20 |
| Example 3 | 75 | 0 | 25 | 25 | 55 | 20 |
| Example 4 | 70 | 0 | 30 | 20 | 60 | 20 |
| Example 5 | 85 | 15 | 0 | 30 | 35 | 35 |
| Comparative Example 1 | 100 | 0 | 0 | 50 | 50 | 0 |
| Comparative Example 2 | 70 | 0 | 30 | 47 | 10 | 43 |
| Comparative Example 3 | 30 | 0 | 70 | 20 | 47 | 33 |
| Comparative Example 4 | 70 | 0 | 30 | 20 | 77 | 3 |

As shown in Table 1 above, polyimide films prepared in Examples 1 to 5 and Comparative Examples 1 to 4 were measured for their respective dielectric constant, dielectric dissipation factor, and glass transition temperature. The results are shown in Table 2 below.

TABLE 2

| | Property | | |
|---|---|---|---|
| | Dk | Df | Tg |
| Example 1 | 3.5 | 0.0023 | 255 |
| Example 2 | 3.5 | 0.0023 | 266 |
| Example 3 | 3.5 | 0.0022 | 263 |
| Example 4 | 3.5 | 0.0023 | 268 |
| Example 5 | 3.4 | 0.0020 | 275 |
| Comparative Example 1 | 3.4 | 0.0017 | 220 |
| Comparative Example 2 | 3.4 | 0.0032 | 240 |
| Comparative Example 3 | 3.6 | 0.0041 | 245 |
| Comparative Example 4 | 3.5 | 0.0030 | 250 |

A method of measuring a dielectric constant (Dk), dielectric dissipation factor (Df), and glass transition temperature of the prepared polyimide films is as follows.

### (1) Dielectric Constant Measurement

A dielectric constant (Dk) of the polyimide films was measured at 10 GHz using a Keysight SPDR meter.

### (2) Dielectric Dissipation Factor Measurement

A dielectric dissipation factor (Df) of the polyimide films left in a 23° C./50% RH environment for 24 hours was measured by a split post dielectric resonator method (SPDR) using a Keysight ENA Series vector network analyzer.

### (3) Glass Transition Temperature Measurement

A glass transition temperature (Tg) of the polyimide films was measured by using DMA to obtain the loss modulus and storage modulus of each polyimide film and utilizing the inflection point in a tangent graph of the loss modulus and storage modulus.

As shown in Table 2 above, the polyimide films prepared according to Examples of the present disclosure not only exhibited a dielectric dissipation factor (Df) of less than 0.0025, but also had excellent thermal stability with a glass transition temperature (Tg) of 240° C. or higher.

Meanwhile, the dielectric constant (Dk) of the polyimide films of all Examples and comparative Examples except Comparative Example 3 of the present disclosure was 3.5 or less.

These results were achieved by the components and composition ratio specified herein. This showed that the content of each component played a decisive role.

Meanwhile, it was confirmed that the dielectric dissipation factors of the polyimide films of Comparative Examples 2 to 4 were higher than those of the polyimide films of Examples 1 to 5. Only the polyimide film of Comparative Example 1 had a lower dielectric dissipation factor than the polyimide films of Examples 1 to 5. However, the polyimide film of Comparative Example 1 exhibited a significantly low glass transition temperature, so the heat resistance was greatly reduced.

From this, it could be expected that the polyimide films of Examples 1 to 5 would be suitable for practical application to electronic components because the polyimide films possessed both properties, which were a low dielectric dissipation factor and a high heat resistance.

Although the present disclosure has been described with reference to Examples thereof, it will be possible for those skilled in the art to make various applications and modifications within the scope of the present disclosure based on the contents.

### INDUSTRIAL APPLICABILITY

As explained above, the present disclosure prepares a polyamic acid solution containing specific components in a specific composition ratio by imidization and provides a polyimide film having low dielectric and high heat resistant properties, thereby the present disclosure can apply in various fields in need of the properties, in particular, to an electronic component such as a flexible metal foil clad laminate.

1. A polyimide film prepared by imidizing a polyamic acid solution containing a dianhydride component comprising two or more types selected from the group consisting of biphenyltetracarboxylic dianhydride (BPDA), pyromellitic dianhydride (PMDA), and p-phenylenebis(trimellitate anhydride) (TAHQ) and a diamine component comprising two or more types selected from the group consisting of oxydianiline (ODA), p-phenylenediamine (PPD), and m-tolidine (mTD),
wherein, the dianhydride component is required to comprise the biphenyltetracarboxylic dianhydride and the p-phenylenebis(trimellitate anhydride).

2. The polyimide film of claim 1, wherein the biphenyltetracarboxylic dianhydride (BPDA), the pyromellitic dianhydride (PMDA), and the p-phenylenebis(trimellitate anhydride) (TAHQ) are contained in amounts of 30 mol % to 70 mol %, 40 mol % or less, and 15 mol % to 35 mol %, respectively, based on 100 mol % of the dianhydride component.

3. The polyimide film of claim 1, wherein the oxydianiline (ODA), the p-phenylenediamine (PPD), and the m-tolidine are contained in amounts of 35 mol % or less, 55 mol % or less, and 45 mol % or more, respectively, based on 100 mol % of the diamine component.

4. The polyimide film of claim 1, wherein the polyimide film comprises a block copolymer made of two or more blocks.

5. The polyimide film of claim 1, wherein the polyimide film comprises a block copolymer,
the block copolymer comprising:
a first block obtained by bringing the dianhydride component and the diamine component into an imidization reaction, the dianhydride component comprising the p-phenylenebis(trimellitate anhydride) (TAHQ) and the diamine component comprising the m-tolidine (mTD) and the oxydianiline (ODA); and
a second block obtained by bringing the dianhydride component and the diamine component into the imidization reaction, the dianhydride component comprising the biphenyltetracarboxylic dianhydride (BPDA) and the pyromellitic dianhydride (PMDA) and the diamine component comprising the m-tolidine (mTD) and the p-phenylenediamine (PPD).

6. The polyimide film of claim 1, wherein the polyimide film has a dielectric dissipation factor (Df) of 0.0025 or less and a glass transition temperature (Tg) of 240° C. or higher.

7. A method of preparing a polyimide film, the method comprising:
preparing a polyamic acid solution by polymerizing a dianhydride component and a diamine component, the dianhydride component comprising two or more types selected from the group consisting of biphenyltetracarboxylic dianhydride (BPDA), pyromellitic dianhydride (PMDA), and p-phenylenebis(trimellitate anhydride) (TAHQ), and the diamine component comprising two or more types selected from the group consisting of oxydianiline (ODA), p-phenylenediamine (PPD), and m-tolidine (mTD); and imidizing the polyamic acid solution,
wherein, the dianhydride component is required to comprise the biphenyltetracarboxylic dianhydride and the p-phenylenebis(trimellitate anhydride).

8. The method of claim 7, wherein the biphenyltetracarboxylic dianhydride (BPDA), the pyromellitic dianhydride (PMDA), and the p-phenylenebis(trimellitate anhydride) (TAHQ) are contained in amounts of 30 mol % to 70 mol %, 40 mol % or less, and 15 mol % to 35 mol %, respectively, based on 100 mol % of the dianhydride component.

9. The method of claim 7, wherein the oxydianiline (ODA), the p-phenylenediamine (PPD), and the m-tolidine are contained in amounts of 35 mol % or less, 55 mol % or less, and 45 mol % or more, respectively, based on 100 mol % of the diamine component.

10. The method of claim 7, wherein the polyimide film has a dielectric dissipation factor (Df) of 0.0025 or less and a glass transition temperature (Tg) of 240° C. or higher.

11. A multilayer film comprising the polyimide film according to claim 1.

12. The multilayer film of claim 11 further comprising a thermoplastic resin layer.

13. (canceled)

14. (canceled)
